(19) United States
(12) Patent Application Publication
(10) Pub. No.: US 2025/0093867 A1
(43) Pub. Date: Mar. 20, 2025

(54) REMOTE ACTUATION SYSTEMS AND METHODS

(71) Applicant: HONEYWELL INTERNATIONAL INC., Charlotte, NC (US)

(72) Inventors: Nasrullah Habeeb M, Bangalore (IN); Saed Mubaslat, Urbana, OH (US); Haritha B., Bangalore (IN); Vaishnavi Cheemala, Bangalore (IN)

(73) Assignee: HONEYWELL INTERNATIONAL INC., Charlotte, NC (US)

(21) Appl. No.: 18/509,558

(22) Filed: Nov. 15, 2023

(30) Foreign Application Priority Data
Sep. 14, 2023 (IN) 202311061910

(51) Int. Cl. G05D 1/00; B64U 50/20; G05D 1/10; H02P 27/08

(52) U.S. Cl. CPC G05D 1/0011; B64U 50/20; H02P 27/08; B64U 2201/20

(57) ABSTRACT

Fly-by-wire vehicle systems and related remote actuation systems and operating methods are provided for actuating a remote flight control component using an individual analog command signal communicated over an individual electrical cable or wire. An exemplary method involves logic, circuitry or other hardware at a remote actuation system receiving an analog input command signal, converting the analog input command signal to a rotational speed command in a commanded rotational direction based on a relationship between a current state of the signal characteristic and a reference state for the signal characteristic, converting the rotational speed command into a power conversion command based at least in part on the rotational speed command and the current state of the motor, and operating power conversion circuitry at the remote actuation system to provide power to the motor in accordance with the power conversion command to achieve the commanded rotation in the commanded rotational direction.

### CROSS REFERENCE TO RELATED APPLICATION

This application claims priority to India Provisional Patent Application No. 20/231,1061910, filed Sep. 14, 2023, the entire content of which is incorporated by reference herein.

### TECHNICAL FIELD

The subject matter described herein relates generally to vehicle systems, and more particularly, embodiments of the subject matter relate to actuation systems for vertical take-off and landing (VTOL) aircraft and other fly-by-wire aircraft systems.

### BACKGROUND

In some modern aircraft, traditional mechanical flight control systems have been replaced with electrically controlled actuators, often referred to as fly-by-wire. Instead of mechanical linkages between cockpit controls and flight control surfaces, propulsion systems and/or lift systems, electrical signals are utilized to communicate movements of cockpit controls to the controllers associated with the appropriate flight control components or systems. Vertical take-off and landing (VTOL) aircraft or other aircraft non-conventional aircraft may include any number of different actuators or effectors arranged or distributed at various locations throughout the body of the aircraft and operated independently of one another to provide lift, propulsion, and/or attitude control for the aircraft (e.g., propellers, lift fans, rotors, flight control surface actuators, and/or the like), which increases the amount of wiring and interfaces required. For smaller aircraft, such as air taxis or other urban air mobility (UAM) vehicles, it is often desirable to minimize the amount of wiring, weight, and associated costs. Other desirable features and characteristics will become apparent from the subsequent detailed description and the appended claims, taken in conjunction with the accompanying drawings and the foregoing technical field and background.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

Fly-by-wire vehicle systems and related remote actuation systems and operating methods are provided for actuating a remote flight control component using an individual analog command signal communicated over an individual electrical cable or wire to a hardware remote actuation system having a reduced number of input/output interfaces. One exemplary method of operating a remote actuation system involves receiving, at the remote actuation system, an analog input command signal having a signal characteristic indicative of a commanded rotation and a commanded rotational direction for a motor associated with the remote actuation system, converting, at the remote actuation system, the analog input command signal to a rotational speed command in the commanded rotational direction based on a relationship between a current state of the signal characteristic of the analog input command signal and a reference state for the signal characteristic of the analog input command signal, converting, at the remote actuation system, the rotational speed command into a power conversion command based at least in part on the rotational speed command and the current state of the motor, and operating power conversion circuitry at the remote actuation system to provide power to the motor in accordance with the power conversion command to achieve the commanded rotation in the commanded rotational direction.

An actuation system is provided that includes a motor, a sensing arrangement to provide measurement data indicative of a current position of the motor, power conversion circuitry coupled to the motor, an interface to receive an analog input command signal, an analog motor drive hardware coupled to the interface to convert the analog input command signal to an output indicative of a rotational speed command in a commanded rotational direction based at least in part on a relationship between a current state of a signal characteristic of the analog input command signal and a reference state for the signal characteristic, and excitation logic coupled to the analog motor drive hardware to convert the output of the analog motor drive hardware into one or more power conversion commands for operating the power conversion circuitry based at least in part on the current position of the motor.

An aircraft system is also provided that includes a flight control component actuatable to influence at least one of a position and an attitude of an aircraft, an electrical cable, a flight control module coupled to the electrical cable to determine an actuation command for adjusting the at least one of the position and the attitude of the aircraft and transmit an analog command signal having a signal characteristic indicative of the actuation command, and an actuation system coupled to the electrical cable to receive the analog command signal. The actuation system includes a motor coupled to the flight control component to actuate the flight control component, power conversion circuitry coupled to the motor, and one or more hardware modules coupled between the electrical cable and the power conversion circuitry, wherein the one or more hardware modules are configured to convert the analog command signal to one or more power conversion commands corresponding to a commanded rotational speed for the motor in a commanded rotational direction for the motor based at least in part on a relationship between a current state of the signal characteristic of the analog command signal and a reference state for the signal characteristic of the analog command signal and operate the power conversion circuitry in accordance with the one or more power conversion commands.

Furthermore, other desirable features and characteristics of the subject matter described herein will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 is a block diagram illustrating a fly-by-wire system suitable for use with a vehicle such as an aircraft in accordance with one or more exemplary embodiments; and

FIG. 2 is a block diagram of an actuation system suitable for use as a remote actuation system to control a flight control component responsive to an input command signal from a flight control module in the fly-by-wire system of FIG. 1 in an exemplary embodiment.

### DETAILED DESCRIPTION

The following detailed description is merely exemplary in nature and is not intended to limit the subject matter of the application and uses thereof. Furthermore, there is no intention to be bound by any expressed or implied theory presented in the preceding technical field, background, brief summary, or the following detailed description.

Embodiments of the subject matter described herein relate to electrically-controlled vehicle systems. For purposes of explanation, the subject matter is described herein primarily in the context of aircraft where flight control components are controlled using electrical signals, however, the subject matter is not necessarily limited to use with aircraft and may be implemented in an equivalent manner for other types of vehicles (e.g., automotive vehicles, marine vessels, or the like). That said, exemplary embodiments may be described herein in the context of urban air mobility (UAM) vehicles or other vertical takeoff and landing (VTOL) aircraft that includes various remote actuation systems that actuate or otherwise operate flight control components which provide lift, propulsion, and/or attitude control for the aircraft, such as, for example, a flight control surface actuator, lift fan, motor, or similar flight control component capable of adjusting or otherwise influencing a position or orientation of the aircraft.

As described in greater detail below, in exemplary implementations, the remote actuation systems are implemented using logic gates, circuitry and/or other hardware components without reliance on microcontrollers or other processors or software at the remote actuation systems, that would otherwise require watchdogs or other monitoring overhead. In this regard, the hardware at a remote actuation system is capable of receiving an analog input command signal, which could have a relatively lower frequency, via an individual electrical cable or wire and converting the analog input command signal into a corresponding rotational speed command and a corresponding commanded direction of rotation based on a current state of a signal characteristic of the analog input command signal in relation to a reference state for the signal characteristic. After converting the analog input command signal into a rotational speed command and commanded rotational direction, the hardware at the remote actuation system converts the rotational speed command into corresponding higher frequency pulse-width modulated (PWM) gate driver command signals or other power conversion commands for operating an inverter or similar power conversion circuitry. The inverter or similar power conversion circuitry at the remote actuation system is operated in accordance with the power conversion commands to excite or apply the appropriate amount of electrical power to the appropriate phases of a motor associated with the remote actuation system to achieve the commanded speed or rate of rotation in the commanded direction of rotation of the motor, thereby operating the flight control component(s) coupled to the motor or otherwise associated with that remote actuation system to adjust the position and/or attitude of the aircraft in the commanded manner.

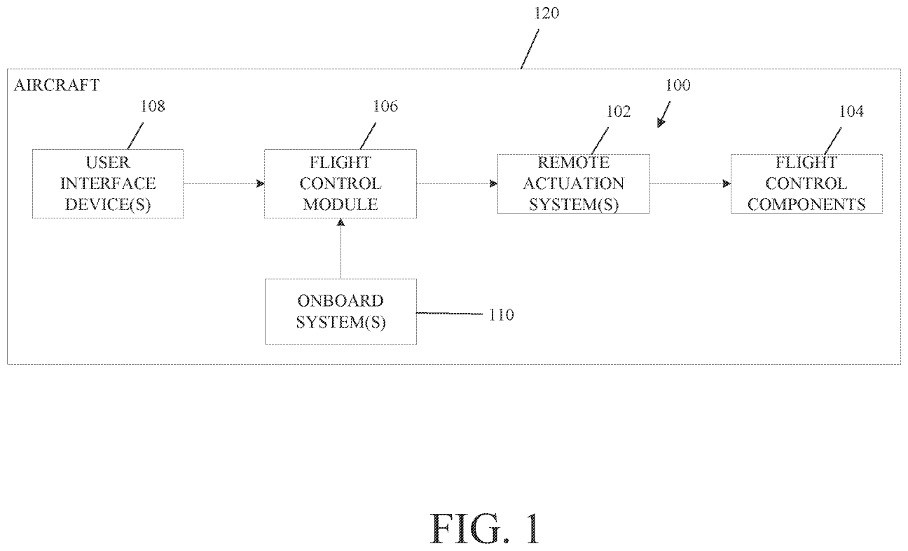

FIG. 1 depicts an exemplary embodiment of a fly-by-wire system 100 suitable for use with a vehicle such as an aircraft 120. In exemplary implementations, the aircraft 120 is realized as a UAM vehicle, a VTOL aircraft, or another aircraft that includes multiple different remote actuation systems 102 that are operable to control or otherwise manage respective flight control components 104 (e.g., propellers, lift fans, flight control surfaces and/or the like) distributed about the body of the aircraft 120, and thereby, control the position, orientation and/or attitude of the aircraft 120. In exemplary implementations, each remote actuation system 102 manages a unique flight control component 104 (or a set of flight control components) that is different from those flight control components 104 managed by other remote actuation system 102. That said, in practice, some implementations may employ redundancy, where more than one remote actuation system 102 is capable of operating a common flight control component 104.

The remote actuation systems 102 are communicatively coupled to a flight control module 106, which generally represents the processing system, processing device, hardware, circuitry, logic, software, firmware and/or other components of the fly-by-wire system 100 that are configured to receive signals indicative of a sensed or measured position, orientation, or adjustment to user interface devices 108 associated with the aircraft 120 and convert the inputs or adjustments received at the user interface devices 108 into corresponding command signals for one or more flight control components 104 and output or otherwise provide the command signals to the remote actuation systems 102. For purposes of explanation, the flight control module 106 may alternatively be referred to herein as a flight control computer (FCC). The flight control computer 106 may be implemented or realized using any suitable processing system and/or device, such as, for example, one or more processors, central processing units (CPUs), controllers, microprocessors, microcontrollers, processing cores and/or other hardware computing resources configured to support the operation described herein. In this regard, each flight control computer 106 may include or access a data storage element (or memory) capable of storing programming instructions for execution that, when read and executed by the flight control computer 106, cause the flight control computer 106 to support operations of the fly-by-wire system 100. In practice, some implementations may employ redundancy, where multiple different instances of the flight control computer 106 independently determine and provide redundant command signals to a remote actuation system 102 concurrently.

The user interface devices 108 may be realized as one or more cockpit user interface devices onboard the aircraft 120, such as, for example, a joystick, lever, switch, knob, line select key, touch panel (or touchscreen), keypad, touchpad, keyboard, mouse or another suitable device adapted to receive input from a user. For example, the user interface devices 108 may be realized as joysticks including one or more sets of sensors configured to sense the position of a respective joystick in a reference direction (e.g., a horizontal or x-reference direction, a vertical or y-reference direction and/or the like), with each sensor being coupled to the flight control computer 106 to provide indicia of the user input position of the respective joystick. That said, it should be noted that although the subject matter may be described herein primarily in the context of pilot inputs or other input received via user interface devices 108 utilized to operate flight control components 104 in fly-by-wire aircraft 120, the subject matter described herein is not intended to be limited to any particular type of input to the flight control computer 106, and may be utilized in the context of any other type of measurement or command data (e.g., flight plan data) that may be input to a flight control module 106 for purposes of determining commands for operating the flight control components 104. Accordingly, the subject matter may be implemented in an equivalent manner for autonomously or remotely controlled aircraft. One or more exemplary arrangements of cockpit user interface devices, sensors, and flight control computers are described and depicted in U.S. Pat. No. 11,155,341, which is incorporated by reference herein.

In practice, onboard systems 110 are communicatively coupled to the flight control computer 106 to provide real-time data and/or information regarding the operation of the aircraft 120 to the flight control computer 106 for analysis in conjunction with the user input received via the user interface device(s) 108. For example, in the context of an aircraft 120, the onboard systems 110 may include one or more avionics systems that support navigation, flight planning, and other aircraft control functions, and in practice, will likely include one or more of the following avionics systems suitably configured to support operation of the aircraft: a flight management system (FMS), a navigation system, a communications system, an autopilot system, an autothrust system, a weather system, an air traffic management system, a radar system, a traffic avoidance system, hydraulics systems, pneumatics systems, environmental systems, electrical systems, engine systems, trim systems, lighting systems, crew alerting systems, electronic checklist systems, an electronic flight bag and/or another suitable avionics system. Based on the data or information received from the respective onboard systems 110 and the user input to a respective user interface device 108, the flight control computer 106 commands for controlling the position of or otherwise operating one or more of the flight control components 104 to adjust the position and/or attitude of the aircraft 120.

During operation of the aircraft, the flight control computer 106 continually analyzes the outputs of the user interface devices 108 and the onboard avionics systems 110 to determine corresponding commands for how the respective flight control components 104 should be operated in response to adjustments or changes to the user interface devices 108 substantially in real-time. In this regard, in exemplary implementations, the flight control computer 106 calculates or otherwise determines a rate or amount of actuation associated with a particular flight control component 104 to adjust the position and/or attitude of the aircraft 120 in a manner corresponding to the user input received via a user interface device 108 and provides a corresponding command signal to the remote actuation system 102 associated with that flight control component 104 to effectuate the received user input.

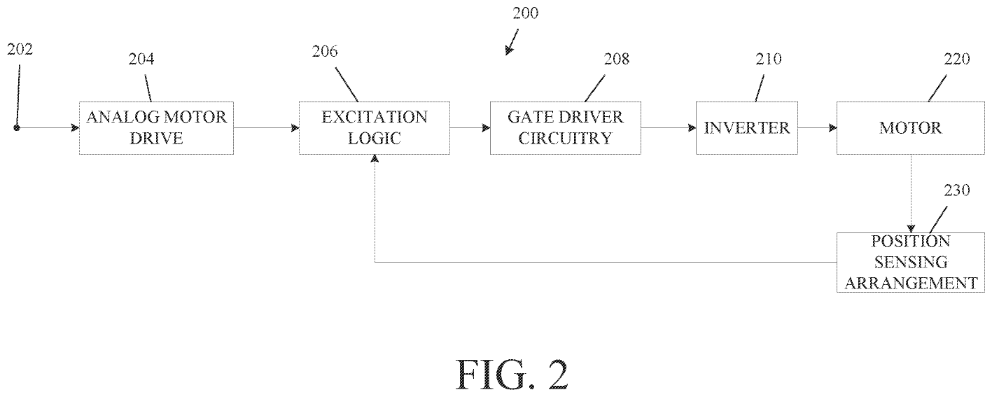

In exemplary embodiments, the flight control computer 106 calculates or otherwise determines a desired rate and direction of actuation for a motor or other actuator associated with a remote actuation system 102 to produce the desired actuation of the flight control component(s) 104 associated with that remote actuation system 102 to adjust the position and/or attitude of the aircraft 120 in the desired manner and provides a corresponding command signal to the remote actuation system 102 for implementation. As described in greater detail below in the context of FIG. 2, in exemplary embodiments, the command signal is realized as an analog command signal having a signal characteristic indicative of a commanded rotation and a commanded rotational direction for a motor associated with the remote actuation system 102 that is capable of being transmitted to the remote actuation system 102 via an individual electrical cable or wire. Thus, rather than relying on costlier and heavier cables that may otherwise be required to carry more complex signals (e.g. motor power signals, motor sense signals, and/or the like) between the flight control computer 106 and a remotely located downstream microcontroller or other processor, the flight control computer 106 provides an individual analog command signal that is resolvable at the remote actuation system 102 using hardware logic using only an individual cable that reduces the weight and cost of distributing command signals to the various remote actuation systems 102 associated with the aircraft 120. For example, in some implementations, the distance between the flight control computer 106 and a remote actuation system 102 on a UAM or VTOL aircraft may be in the range of about 40 feet or more, with as many as ten or more remote actuation systems 102 (e.g., to control any number of propellers, flaps, rudders, etc.), depending on the type and size of the aircraft 120. In addition to reducing the cost and weight of the aircraft 120, using an individual analog command signal also reduces the susceptibility to electromagnetic interference (EMI) and simplifies the EMI protection by reducing the number of input/output (I/O) pins for communications, thereby reducing the number of attenuation filters and reducing susceptibility to conducted or radiated emissions, noise at the I/O pins or the wire bundle, or lightning induced transients. In practice, the cable utilized to communicate the analog command signal may be realized as an RS-232 cable, an RS-422 cable, an RS-485 cable, an ARINC 429 cable, an ARINC 610 cable, an ARINC 622 cable, an ARINC 629 cable or another cable suitable for avionics applications.

FIG. 2 depicts an exemplary embodiment of an actuation system 200 suitable for use as a remote actuation system 102 in the fly-by-wire system 100 of FIG. 1. In this regard, the actuation system 200 includes an actuator 220 that is capable of being mechanically coupled to or otherwise configured to actuate a flight control component 104 to influence the position and/or attitude of an aircraft 120, as described above. For purposes of explanation, the subject matter is described herein in the context of the actuator 220 being realized as a motor that is operable using a power conversion arrangement such as an inverter 210; however, it should be appreciated that the subject matter described herein is not necessarily limited to any particular type of actuator, power conversion arrangement or combination thereof.

The illustrated actuation system 200 includes an analog input interface 202, which generally represents the pin, connector, terminal, port or other node associated with the actuation system 202 capable of being connected or otherwise coupled to an electrical cable for receiving an analog input command signal from a flight control computer or other supervisory control module external to the actuation system 200. The actuation system 200 includes an analog motor drive module 204, which generally represents the logic gates, circuitry and/or other hardware components that are coupled to the analog input interface 202 to receive the analog input command signal and automatically convert the analog input command signal into a corresponding rotational speed command and commanded rotational direction for the motor 220 to produce the desired actuation of a flight control component. In this regard, the analog motor drive module 204 may include logic or other circuitry that is configured to compare the current input state of a signal characteristic of the analog input command signal to a reference state for the signal characteristic, and based on the comparison, identify the commanded rotational speed and direction for the motor 220.

For example, referring to FIG. 2 with reference to FIG. 1, in one or more implementations, the flight control computer 106 is configured to provide the analog input command signal as a direct current (DC) signal with a magnitude of DC current that indicates both the commanded rotational speed and the commanded rotational direction for the motor 220 in relation to a reference DC current, where based on the relationship between the input amount of DC current and the reference DC current, the analog motor drive module 204 outputs or otherwise generates corresponding command signals indicative of the commanded rotational speed and direction for the motor 220. For example, in one implementation, the analog motor drive module 204 is configured for a reference DC current magnitude that is associated with zero revolutions per minute (RPM) for the motor 220, where an analog input command signal having an input DC current magnitude greater than the reference DC current magnitude indicates a first rotational direction (e.g., clockwise) for actuating the motor 220 and an analog input command signal having an input DC current magnitude less than the reference DC current magnitude indicates the opposing rotational direction (e.g., counterclockwise) for the motor 220. In some implementations, the analog motor drive module 204 may be configured to support an offset threshold, such that the input DC current magnitude must be greater than or less than the reference DC current magnitude by at least the offset threshold. For example, the analog motor drive module 204 may include circuitry and logic configured for a reference DC current magnitude of 10 milliamperes (mA) corresponding to a standstill or 0 RPM state and an offset threshold of 1 mA, such that an analog input command signal having an input DC current magnitude greater than 11 mA (e.g., the sum of the reference current and the offset threshold) indicates a first rotational direction (e.g., clockwise), an analog input command signal having an input DC current magnitude less than 9 mA (e.g., the reference current minus the offset threshold) indicates the opposing rotational direction (e.g., counterclockwise), and an analog input command signal within the offset threshold (e.g., between 9 mA and 11 mA) results in a standstill condition.

In addition to circuitry and logic to convert the input DC current magnitude to a commanded rotational direction, the analog motor drive module 204 may include circuitry and logic configured to convert the input DC current magnitude to a commanded rotational speed for the motor 220. For example, the analog motor drive module 204 may be configured to support a potential range of input DC current magnitudes that linearly maps, correlates or otherwise corresponds to the range of potential rotational speeds for the motor 220, for example, by mapping the relative percentage for the input DC current magnitude to a corresponding percentage of the maximum rotational speed for the motor 220. Continuing the above example, for the clockwise direction, the analog motor drive module 204 may be configured to support a potential range of input DC current magnitudes of 11 mA to 18 mA, where the difference between the input DC current magnitude and the lower clockwise current threshold (11 mA) is divided by the range of input DC current magnitudes (7 mA) to identify the commanded percentage of the maximum RPMs for the motor 220 that is desired by the flight control computer 106 (e.g., where an input DC current magnitude of 18 mA corresponds to the maximum RPM of the motor 220 in the clockwise direction), with the analog motor drive module 204 being similarly configured to linearly map an input DC current magnitude to a RPM command in the counterclockwise direction (e.g., where an input DC current magnitude of 2 mA corresponds to the maximum RPM of the motor 220 in the counterclockwise direction). In such implementations, input DC current magnitudes outside the supported range associated with the hardware of the analog motor drive module 204 (e.g., 2 mA to 18 mA) may result in an inability of the actuation system 200 to continue to respond to or otherwise track the analog input command signal (e.g., a loss of control margin with respect to the motor 220).

It should be noted that the subject matter described herein is not limited to the DC current magnitude and may be implemented in an equivalent manner in the context of any other suitable signal characteristic of an analog input signal, such as, for example, an input voltage level, an input duty cycle, an input analog signal frequency, and/or the like. For example, similar to the above example described in the context of an input DC current magnitude, the analog motor drive module 204 may be configured to support a reference duty cycle of 50% for a standstill condition with a 5% offset threshold, where an analog input command signal having a duty cycle between 55% to 95% is mapped to a clockwise rotation of the motor (e.g., where a 95% duty cycle associated with the analog input command signal corresponds to the maximum RPM of the motor 220 in the clockwise direction) and a duty cycle between 5% to 45% is mapped to a counterclockwise rotation of the motor (e.g., where a 5% duty cycle associated with the analog input command signal corresponds to the maximum RPM of the motor 220 in the clockwise direction), with input duty cycles between 45% and 55% resulting in a standstill condition and duty cycles above 95% or below 5% may result in an inability to effectuate the command. In this regard, the duty cycle associated with the analog input command signal received at the analog input interface 202 may be different from the duty cycles associated with power conversion command signals for operating the inverter 210. For example, an analog input command signal with a duty cycle of 5% corresponding to a maximal rate of rotation in a particular direction may result in a corresponding duty cycle of 100% for one or more power conversion command signals to maximize the input power applied to a particular phase of the motor 220. In practice, the frequency associated with the PWM duty cycles and corresponding PWM command signals may be different from, independent of, and relatively higher than the frequency associated with the analog input command signal.

It should be noted that the subject matter described herein is not necessarily limited to any particular signal characteristic for the analog input command signal, any particular reference, offset thresholds or ranges for the particular signal characteristic for the analog input command signal, or any particular manner for mapping or converting a particular signal characteristic within a supported command range to a corresponding rotational speed command. For example, although the subject matter may be described herein in the context of the hardware of the analog motor drive module 204 linearly mapping or converting the input signal characteristic within a supported range to a corresponding rotational speed command, in other implementations, the hardware of the analog motor drive module 204 may be configured to support a nonlinear relationship between the input signal characteristic and the corresponding rotational speed and direction commands determined by the analog motor drive module 204.

The output of the analog motor drive module 204 is coupled to the input of an excitation logic module 206, which generally represents the logic gates, circuitry and/or other hardware components that are coupled to a position sensing arrangement 230 associated with the motor 220 to convert the rotational speed command and commanded rotational direction from the analog motor drive module 204 into power conversion commands for operating the inverter 210 to apply voltage and excite phases of the motor 220 in the appropriate sequence and manner for achieving the commanded rotational speed in the commanded rotational direction given the current position or state of the motor 220. Based on the current rotor position indicated by the rotor position measurement data received from the position sensing arrangement 230 and the commanded rotational direction, the excitation logic module 206 determines the appropriate sequence or order for exciting the phases of the motor 220 to produce rotation in the commanded direction and generates corresponding power conversion commands for operating the corresponding phases (or phase legs) of the inverter 210 to provide input power to those phases of the motor 220 in that order. Additionally, based on the commanded rotational speed, the excitation logic module 206 determines the corresponding magnitude or duty cycle for the power conversion commands to result in the appropriate amount of power input to the motor 220 to achieve the commanded rotational speed.

In the illustrated embodiment, the output of the excitation logic module 206 is coupled to gate driver circuitry 208, which generally represents the transistors, switches and/or other circuitry that is configured to activate or deactivate respective phases of the inverter 210 in accordance with the power conversion command signals from the excitation logic module 206 to enable the desired direction of current flow through the respective phases of the motor 220 to produced rotation of the rotor of the motor 220 in the commanded rotational direction. The gate driver circuitry 208 also activates or deactivates the respective phases of the inverter 210 for a duration of time in accordance with the power conversion command signals from the excitation logic module 206 to provide the amount of input power for achieving the commanded rotational speed. For example, in one or more implementations, the power conversion command signals output by the excitation logic module 206 are realized as pulse-width modulated (PWM) duty cycle command signals or are otherwise indicative of desired PWM duty cycles corresponding to the duration of time for which each respective phase leg of the inverter 210 should be activated to provide the amount of input power to the respective phases of the motor 220 that achieves the commanded rotational speed.

The inverter 210 generally represents the combination of transistors, diode and/or other power conversion circuitry that is operable to convert DC input power from an energy source into alternating current (AC) output power that is applied to the respective phases of the motor 220 in accordance with the power conversion command signals determined by the excitation logic module 206. In this regard, the power conversion commands generated by the excitation logic module 206 cause the gate driver circuitry 208 to activate the phase legs of the inverter 210 to apply the input DC voltage and/or current for a duration of a control period that corresponds to the PWM duty cycle determined by the excitation logic module 206.

In one or more exemplary implementations, the motor 220 is realized as a brushless DC (BLDC) electric motor where the inverter 210 is operated to provide input current to the different phases of the motor stator windings in the commanded sequence corresponding to the power conversion commands generated by the excitation logic module 206 to cause the rotor of the motor 220 to rotate in the commanded direction, where the duty cycle or duration of activation of the respective inverter phase legs influences the amplitude of the current flow through the motor stator windings to control the rotational speed of the rotor. In exemplary implementations when the motor 220 is realized as a BLDC motor, the position sensing arrangement 230 is realized as a set of Hall effect sensors that provided measurement data indicative of the current state or position of the rotor of the motor 220 in relation to the stator windings, which, in turn, is utilized by the excitation logic module 206 to determine which set of motor stator windings should be excited to produce subsequent rotation of the rotor based on the angular position of the rotor with respect to the motor stator windings. That said, it should be appreciated that the subject matter described herein is not limited to BLDC motors or Hall effect sensors, and in practice, the subject matter may be implemented in an equivalent manner in the context of a different type of motor 220 and/or a different type of rotor position sensing arrangement 230 (e.g., encoders, resolvers, or the like).

Referring to FIG. 2 with continued reference to FIG. 1, by virtue of the subject matter described herein, remote actuation systems can be deployed using a hardware-based solution that does not require microcontrollers, controller area network (CAN) controllers and/or the like at the remote actuation systems, thereby reducing the costs that would otherwise be associated with software development, watchdogs, and/or the like for the remote actuation systems. Moreover, use of a single analog input command signal to convey both the commanded rotational speed and direction for the motor enables use of an individual cable or wire that reduces the cabling costs and weight associated with routing command signals from a central flight control computer or other supervisory control module to different actuation systems that are distributed, dispersed, or otherwise remotely located about the body of the vehicle. This reduces the EMI design requirements or complexity, in addition to reducing the digital design complexity by relying on analog signaling.

For the sake of brevity, conventional techniques related to avionics systems, fly-by-wire systems, motor controls, power converters, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims.

Those of skill in the art will appreciate that the various illustrative logical blocks, modules, circuits, and algorithm steps described in connection with the embodiments disclosed herein may be implemented in varying ways for each particular application, but such implementation decisions should not be interpreted as causing a departure from the scope of the present invention. In addition, those skilled in the art will appreciate that embodiments described herein are merely exemplary implementations.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, the foregoing description may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. For example, two elements may be coupled to each other physically, electronically, logically, or in any other manner, through one or more additional elements. Thus, although the drawings may depict one exemplary arrangement of elements directly connected to one another, additional intervening elements, devices, features, or components may be present in an embodiment of the depicted subject matter. In addition, certain terminology may also be used herein for the purpose of reference only, and thus are not intended to be limiting.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of operating a remote actuation system, the method comprising:
receiving, at the remote actuation system, an analog input command signal having a signal characteristic indicative of a commanded rotation and a commanded rotational direction for a motor associated with the remote actuation system;
converting, at the remote actuation system, the analog input command signal to a rotational speed command in the commanded rotational direction based on a relationship between a current state of the signal characteristic of the analog input command signal and a reference state for the signal characteristic of the analog input command signal;
converting, at the remote actuation system, the rotational speed command into a power conversion command based at least in part on the rotational speed command and the current state of the motor; and
operating power conversion circuitry at the remote actuation system to provide power to the motor in accordance with the power conversion command to achieve the commanded rotation in the commanded rotational direction.

2. The method of claim 1, wherein receiving the analog input command signal comprises receiving the analog input command signal via an individual electrical cable coupled to an interface associated with the remote actuation system.

3. The method of claim 2, wherein converting the analog input command signal comprises analog motor drive hardware coupled to the interface converting the analog input command signal based on the relationship and providing an output indicative of the rotational speed command and the commanded rotational direction.

4. The method of claim 1, wherein converting the analog input command signal comprises analog motor drive hardware at the remote actuation system determining the commanded rotational direction based on the relationship between the current state of the signal characteristic of the analog input command signal and the reference state for the signal characteristic, determining the rotational speed command based at least in part on a difference between the current state of the signal characteristic of the analog input command signal and the reference state for the signal characteristic, and generating an output indicative of the rotational speed command in the commanded rotational direction.

5. The method of claim 4, wherein converting the rotational speed command into the power conversion command comprises excitation logic generating one or more pulse-width modulated (PWM) duty cycle commands based at least in part on the commanded rotational direction and the current state of the motor, wherein a respective duty cycle of the one or more PWM duty cycle commands is influenced by the rotational speed command.

6. The method of claim 5, wherein operating the power conversion circuitry comprises operating an inverter coupled to the motor at the remote actuation system in accordance with the one or more PWM duty cycle commands.

7. The method of claim 6, further comprising obtaining, at the excitation logic, measurement data indicative of a current position of a rotor of the motor from a positioning sensing arrangement associated with the remote actuation system, wherein the excitation logic generates the one or more PWM duty cycle commands for respective phases of the inverter based at least in part on the commanded rotational direction and the current position of the rotor.

8. An actuation system comprising:
a motor;
a sensing arrangement to provide measurement data indicative of a current position of the motor;
power conversion circuitry coupled to the motor;
an interface to receive an analog input command signal;
an analog motor drive hardware coupled to the interface to convert the analog input command signal to an output indicative of a rotational speed command in a commanded rotational direction based at least in part on a relationship between a current state of a signal characteristic of the analog input command signal and a reference state for the signal characteristic; and
excitation logic coupled to the analog motor drive hardware to convert the output of the analog motor drive hardware into one or more power conversion commands for operating the power conversion circuitry based at least in part on the current position of the motor.

9. The actuation system of claim 8, wherein the sensing arrangement comprises a position sensing arrangement to provide rotor position measurement data indicative of the current position of a rotor of the motor, wherein the excitation logic is configured to convert the output of the analog motor drive hardware into the one or more power conversion commands for operating the power conversion circuitry to actuate the rotor in the commanded rotational direction based at least in part on the current position of the rotor.

10. The actuation system of claim 9, wherein:
the sensing arrangement comprises one or more Hall effect sensors; and
the motor comprises a brushless direct current (BLDC) motor.

11. The actuation system of claim 8, wherein the interface comprises an individual pin for connecting the actuation system to an individual electrical cable for receiving the analog input command signal via the individual electrical cable.

12. The actuation system of claim 8, wherein the analog motor drive hardware is configured to determine the commanded rotational direction based on the relationship between the current state of the signal characteristic of the analog input command signal and the reference state for the signal characteristic, determine the rotational speed command based at least in part on a difference between the current state of the signal characteristic of the analog input command signal and the reference state for the signal characteristic, and generate the output indicative of the rotational speed command in the commanded rotational direction.

13. The actuation system of claim 8, wherein the one or more power conversion commands comprise one or more pulse-width modulated (PWM) duty cycle commands generated by the excitation logic based at least in part on the commanded rotational direction and the current position of the motor, wherein a respective duty cycle of the one or more PWM duty cycle commands is influenced by the rotational speed command.

14. The actuation system of claim 13, further comprising an inverter coupled to the motor and gate driver circuitry coupled between the excitation logic and the inverter, wherein the gate driver circuitry is configured to operate the inverter in accordance with the one or more PWM duty cycle commands.

15. The actuation system of claim 14, wherein the sensing arrangement comprises a position sensing arrangement to provide rotor position measurement data indicative of the current position of a rotor of the motor, wherein the excitation logic generates the one or more PWM duty cycle commands for respective phases of the inverter based at least in part on the commanded rotational direction and the current position of the rotor.

16. An aircraft system comprising:
a flight control component actuatable to influence at least one of a position and an attitude of an aircraft;
an electrical cable;
a flight control module coupled to the electrical cable to determine an actuation command for adjusting the at least one of the position and the attitude of the aircraft and transmit an analog command signal having a signal characteristic indicative of the actuation command; and
an actuation system coupled to the electrical cable to receive the analog command signal, wherein the actuation system comprises:
a motor coupled to the flight control component to actuate the flight control component;
power conversion circuitry coupled to the motor; and
one or more hardware modules coupled between the electrical cable and the power conversion circuitry, wherein the one or more hardware modules are configured to convert the analog command signal to one or more power conversion commands corresponding to a commanded rotational speed for the motor in a commanded rotational direction for the motor based at least in part on a relationship between a current state of the signal characteristic of the analog command signal and a reference state for the signal characteristic of the analog command signal and operate the power conversion circuitry in accordance with the one or more power conversion commands.

17. The aircraft system of claim 16, wherein the one or more hardware modules are configured to convert a magnitude of a direct current (DC) input current associated with the analog command signal to the one or more power conversion commands based at least in part on a relationship between the magnitude of the DC input current and a reference value for the DC input current.

18. The aircraft system of claim 17, wherein the one or more power conversion commands comprise one or more pulse-width modulated (PWM) duty cycle commands corresponding to the magnitude of the DC input current.

19. The aircraft system of claim 16, wherein the one or more hardware modules are configured to convert at least one of a duty cycle or a frequency associated with the analog command signal to the one or more power conversion commands based at least in part on a relationship between the current state of the least one of the duty cycle or the frequency and a reference value for the least one of the duty cycle or the frequency.

20. The aircraft system of claim 19, wherein the one or more power conversion commands comprise a plurality of pulse-width modulated (PWM) duty cycle commands to operate the power conversion circuitry to actuate the motor in the commanded rotational direction corresponding to a difference between the current state of the least one of the duty cycle or the frequency and the reference value for the least one of the duty cycle or the frequency.
